(19) United States
(12) Patent Application Publication
(10) Pub. No.: US 2008/0001321 A1
(43) Pub. Date: Jan. 3, 2008

(54) Dual lamp system

(75) Inventors: C. Richard Panico, Medford, MA (US); Louis R. Panico, Danvers, MA (US)

Correspondence Address: WILMERHALE/BOSTON, 60 STATE STREET, BOSTON, MA, 02109, US

(73) Assignee: Xenon Corporation, Wilmington, MA (US)

(21) Appl. No.: 11/900,672

(22) Filed: Sep. 12, 2007

Related U.S. Application Data
(63) Continuation of application No. 10/139,600, filed on May 6, 2002, now abandoned.
(63) Continuation of application No. 10/105,797, filed on Mar. 25, 2002, now abandoned.
(60) Provisional application No. 60/288,733, filed on May 4, 2001.

(51) Int. Cl. B29D 11/00

(52) U.S. Cl. 264/2.7; 118/641

(57) ABSTRACT

A pulse lamp system has two or more lamps for providing pulses with common electronics to perform processing such as curing coatings, curing adhesives, tilt management, and optical disk initialization.

### CROSS REFERENCE TO RELATED APPLICATION

This application is a continuation of U.S. application Ser. No. 10/139,600 filed May 6, 2002, which claims priority to U.S. application Ser. No. 60/288,733, filed May 4, 2001, and which is a continuation-in-part of U.S. application Ser. No. 10/105,797 filed Mar. 25, 2002, which claims priority to U.S. application Ser. No. 60/278,774, filed Mar. 26, 2001, all of which are incorporated herein by reference.

### BACKGROUND OF THE INVENTION

It is generally known to use pulsed light for aspects of manufacturing optical storage media, including for curing adhesive bonding between disks and for initialization. Known pulsed light systems generally include a power supply, a capacitor bank charged by the power supply, a pulse configuration circuit for shaping the height and width of a pulse, and a lamp. As indicated in the commonly assigned application published as WO 00/26029, which is incorporated by reference the lamp can be a spiral lamp, particularly when used for processing optical media, such as CDs or DVDs.

### SUMMARY OF THE INVENTION

A system and method utilize two or more lamps, preferably operated from a single set of electronics, although some components may be used in common and others separately for each lamp. The two or more lamps can be discharged in a variety of sequences, including alternating sequences. With duplication of some or all electronics, cost and space requirements can be reduced.

The system and method may be used for different types of workpieces, such as and without limitation, optical storage media such as CDs and DVDs for curing a coating or for adhesive bonding. The system and method can be used for tilt management of DVDs or other workpieces by providing some degree of correction for a workpiece that has some degree of tilting or warping.

This method of dual (or more) lamps can also assists in high speed processing for semiconductors, flat panel displays, eyeglass lenses, and other products for which it may be desirable to provide a flash lamp to different sides of a product.

The present invention thus includes a number of aspects, including a system for providing pulsed light to a workpiece with two or more lamps that can be separately triggered such that a pulse can be provided from one side one or more times followed by a pulse on the other side one or more times, with the pulse characteristics being the same or different from one pulse to the next. The present invention also includes a method of triggering one lamp for one or more pulses and then another lamp for one or more pulses (and potentially third or more lamps), and for providing such controls such that the pulses may be the same provided from one lamp to the other or different.

The systems and methods herein also include using a flash lamp to provide a short duration pulse (less than 1,000 microseconds) to initialize an optical disk. The optical disk is preferably exposed as a whole to the pulse lamp. The energy is preferably provided with lower power from a shorter distance, such as less than 1 inch. The proximity from the lamp to the disk makes the surface temperature rapidly rise then fall rapidly, thereby preventing surface damage.

Other features and advantages will become apparent from the following detailed description, drawings, and claims.

### BRIEF DESCRIPTION OF THE DRAWINGS

FIG. 1 is a block diagram of a dual lamp system.

FIG. 2 shows an example of a set of pulses to multiple lamps.

### DESCRIPTION

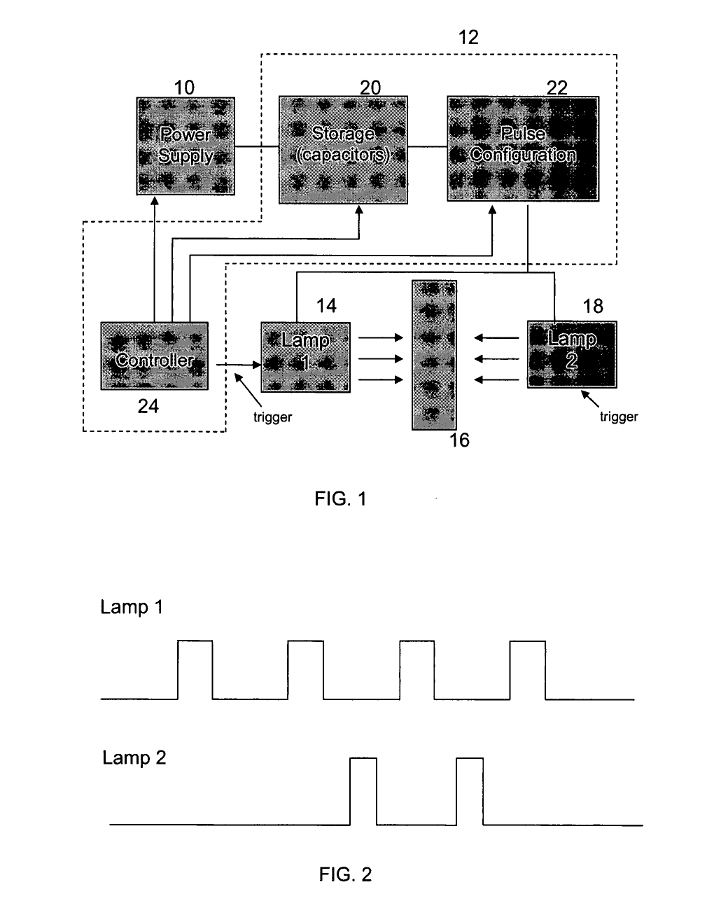

Referring to FIG. 1, an apparatus can include generally conventional flash lamp hardware, such as that used in a model RC-742 pulsed lamp system of the type sold by Xenon Corporation, located in Woburn, Mass. The system includes a power supply 10, circuitry 12 for providing short duration pulses, and pulse lamps 14 and 18, which may include xenon gas. Circuitry 12 has energy storage (capacitor bank) 20, and pulse configuration circuitry 22. The lamps 14 and 18 are provided with separate triggers from a controller 24 that causes the lamps to provide pulses.

The lamp can be one of several types, and the shape of the lamp can be a conventional linear shape or shaped in a spiral. The lamp would generally reside in a housing and provide a pulse of light to a workpiece 16, such as an optical disk, such as a DVD. The pulse can be provided through a window that may filter some wavelengths of the pulse light, such as the infrared components to reduce heating of the workpiece. The lamp system may also include a conventional cooling mechanism, such as a fan, or the device could be air cooled.

With the use of two or more lamps, each separately triggered by a controller, such as a microprocessor, programmable logic array, or other logic, computing, or timing device, the lamps can be controlled to provide pulses in an alternating fashion —a pulse from the first lamp, then a pulse from the second lamp until a sufficient number of pulses have been used for the task. Rather than simple back and forth alternation, the system can provide for one lamp to have two or more pulses before the other has one or more pulses, or to provide a train of pulses to one side then alternate. FIG. 2 shows an example of a pattern with some successive pulses and alternation.

The pulses are preferably not provided simultaneously, although they could be for some applications. In the case of simultaneous use, there may be a need for more duplication of electronics, while the embodiment of FIG. 1 has substantially no duplication.

While the system of the present invention has been described thus far as providing for alternate but identical pulses, by controlling the pulse configuration circuitry, a controller could cause a pulse having one characteristic to be provided from one lamp and a pulse having a different characteristic to be provided from another lamp in successive pulses.

The system can be used to help correct product deformation. In the area of DVDs, one type of deformation is referred to as tilt management, but the benefits could apply to any product that may have a bending or warping type of deformation. In the case of a DVD in which two substrates are bonded together and the adhesive for the bonding is cured through the use of pulsed light, tilt may be introduced in the bonding process, but also may be introduced earlier in the original manufacturing process when the substrates are manufactured. By alternating pulses in an appropriate manner, depending on the product and degree of tilt, that the tilt can be at least partially corrected. This correction can occur through the use of more pulses on one side, and then one or more pulses on the other, or by an alternating train of pulses. These pulses can alter the concavity or convexity of the disk, and thus the system allows for correction of tilt introduced when the substrates are manufactured or bonded. By using inspection techniques, such as those similar for use with machine vision and inspection of parts, the system can determine the degree of warping and adjust the pulses accordingly.

The system used to provide tilt management is described as having many common components for multiple lamps, but alternatively, more of the components could be separate and separately controlled. There number of components in common is a function of cost, need, and desire for controlling parameters.

The system can be used for other processing in which pulsed light is desirable, such as in the manufacture of flat panel displays and eyeglass lenses.

Initialization can also be provided for optical disks. An entire surface of an optical disk can be exposed with a flash lamp without causing process damage and with an added benefit of noise reduction. The time for processing can be about 1 to 3 seconds, as compared to known laser methods which take more than 20 seconds. Furthermore, a laser has a shorter life than a flash lamp.

A method for initialization was performed with a RC-742 pulse lamp system. Exemplary ranges of operating parameters of the system include:

Pulse duration: 1 to 1,000 microseconds measured at 1/3rd peak value

Energy per pulse: 1 to 2,000 joules

Radiated time: 0.1 to 10 seconds

Distance from substrate: less than 1″

Lamp configuration (shape): linear or spiral

Lamp type: Quartz, Suprasil, or Sapphire

Spectrum: 100 to 1,000 nanometers

Lamp Cooling: ambient, forced air, or water

Wavelength selection outside the lamp: none or IR filter

Lamp housing window: Quartz, suprasil, or saffire

The system also includes a method of initializing an optical disk. Unlike some other initialization techniques with a flash lamp, this method preferably uses a short duration pulse (less than 1000 microseconds), and is performed with lower power from a shorter distance than prior proposed methods that tend to use higher power over a greater distance. The close proximity advantageously makes the surface temperature rapidly rise, then fall rapidly, thereby preventing surface damage. The temperature drops rapidly between pulses. These differences (or at least some subset of these differences) enable the processing rapidly without the damage and with good noise qualities. It is further believed that the magnetic field from the flash lamp may be beneficial to the initializing process. Thus the power is sufficient to effect the phase change from about 1 inch or less without damaging the disk.

The method can be used with conventional DVDs, and is not limited to any particular type of adhesive or DVD substrate. The methods thus assist in the high speed manufacture of DVDs.

Having described an embodiment of the present invention, it should be apparent that modifications can be made without departing from the scope of the claims. For example, as indicated above, a range of parameters, materials, distances, powers, window materials, use of a filter, and use of a heating plate beneath the disc or other supplemental heating or cooling are all further possibilities.

What is claimed is:

1. A flash lamp system for use on a workpiece comprising:
a first flash lamp positioned to provide one or more pulses of light to one side of the workpiece, each of the pulses having a duration of 1000 microseconds or less;
a second flash lamp positioned to provide one or more pulses of light to another side of the workpiece and positioned such that the first and second lamps can provide pulses to the workpiece, each of the pulses having a duration of 1000 microseconds or less; and
a control system for causing each of the first and second flash lamps to provide pulses to the workpiece, wherein the control system causes at least some of the pulses to be delivered by the first and second flash lamps at different times.

2. The system of claim 1, wherein the control system includes a controller, a bank of capacitors, and pulse configuration circuitry, the controller causing a pulse with voltage from the capacitors and with a configuration defined by the pulse configuration circuitry.

3. The system of claim 2, wherein the controller causes the first and second flash lamps to provide pulses with duration of 1000 microseconds or less in an alternating manner.

4. The system of claim 3, wherein one pulse is provided by the first lamp and then the second lamp before a pulse is provided again by the first lamp.

5. The system of claim 3, wherein multiple pulses are provided by one lamp before a pulse is provided by the other lamp.

6. The system of claim 1, wherein the lamps provide an unequal number of pulses.

7. The system of claim 6, wherein the number of pulses provided by each lamp is designed to change warping in the workpiece.

8. The system of claim 1, wherein the workpiece is a DVD and the lamps are used to cure an adhesive between layers of the DVD.

9. The system of claim 1, wherein the workpiece is a DVD and the lamps are used to cure an adhesive between layers of the DVD.

10. A method for use with a flash lamp system having a first flash lamp positioned on one side of a workpiece, and a second flash lamp positioned on another side of a workpiece; comprising causing each of the first and second flash lamps to provide pulses to the workpiece at different times, the pulses having a duration of 1000 microseconds or less.

11. The method of claim 10, wherein a controller causes the first and second flash lamps to provide pulses in an alternating manner.

12. The method of claim 11, wherein one pulse is provided by one flash lamp before a pulse is provided by the other flash lamp.

13. The method of claim 11, wherein multiple pulses are provided by one flash lamp before a pulse is provided by the other flash lamp.

14. The method of claim 10, wherein the flash lamps provide an unequal number of pulses.

15. The method of claim 10, wherein the number and timing of pulses are designed to correct a warping in the workpiece.

16. The method of claim 15, wherein the workpiece is a DVD.

17. The method of claim 10, wherein the workpiece is a DVD.

18. A method for use with a flash lamp system having a first lamp positioned on one side of a workpiece, and a second lamp positioned on another side of a workpiece opposite to the first side, the method comprising causing each of the first and second flash lamps to provide pulses to the workpiece at different times in a controlled manner, the pulses having a duration of 1000 microseconds or less.

19. The method of claim 18, wherein the pulses are provided from the first and second flash lamps in an alternating manner.

20. The method of claim 18, wherein multiple pulses are provided from the first lamp before one or more pulses are provided by the second lamp.
